(19) United States
(12) Patent Application Publication
(10) Pub. No.: US 2007/0083660 A1
(43) Pub. Date: Apr. 12, 2007

(54) Amorphic Computing

(76) Inventor: Barry W. Thornton, Austin, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/534,454

(22) Filed: Sep. 22, 2006

Related U.S. Application Data
(60) Provisional application No. 60/720,267, filed on Sep. 23, 2005.

(51) Int. Cl. G06F 15/16

(52) U.S. Cl. 709/227

(57) ABSTRACT

System and method for providing computer resources to users. A first device is coupled to multiple human interface devices (HIDs), and a second device is coupled to multiple computing resources. The first device establishes a connection with the second device over a network, and in response to user input specifying a task, provides first user interface signals generated by the HIDs specifying the task to the second device. The second device receives the task specification from the first device, determines one or more of the resources operable to perform the task, invokes performance of the task by at least one of the resources, and/or the second device, and provides second user interface signals to the first device, including results of the task. The first device receives the second user interface signals from the second device, and provides them to one or more of the HIDs for presentation to the user.

### BACKGROUND OF THE INVENTION

1. Field of the Invention

The present invention relates generally to providing computer resources, and more particularly to the provision of distributed resources to users via a secure remote interface.

2. Description of the Related Art

The components of a computer system (such as PCs, minicomputers and mainframes), may be divided into two functional units—the computing system and the human interface (or “HI”) to the computing system. For a PC, the computing system may be the processor (i.e., CPU), dynamic random access memory, non-volatile memory, power supply and similar components. The computing system may be included in a chassis that holds the motherboard, power supply, memory and the like. The human interface, on the other hand, may include those devices that humans use to transfer information to and/or receive information from the computing system. The most commonly recognized devices which form part of the human interface to the computing system include the display, keyboard, mouse and printer. The human interface may include a variety of other devices, such as a joystick, trackball, touchpad, microphone, speakers, and telephone, as well as other devices too numerous to specifically mention.

In current computer systems, e.g., current PC architectures, the human interface (e.g., the display monitor, mouse, and keyboard, etc.) is closely located to the computer system, by a distance typically less than about 10 feet. The computing system generates and/or receives human interface signals, e.g., display monitor, mouse and keyboard formatted data, which are provided directly to/from the human interface or desktop via individual specialized cables, or by wireless means. For example, for most PCs installed at workstations, the computer display, keyboard and mouse rest on the desktop while the computer chassis that holds the computing system rests on the floor underneath the desktop. As is well known, two or more computing systems may be connected together in a network configuration.

While the above-described network configuration is quite common in many business establishments, recently, a number of issues, in particular, security concerns, have been raised in connection with such network designs. Business contacts, vendor information, contracts, reports, compilations, proprietary software, access codes, protocols, correspondence, account records, and business plans are just some of the fundamental assets of a company which are oftentimes accessible from an employee's computer where they can be quickly copied onto a floppy disk and stolen.

Disk and CD drives may also be used to introduce illegal, inappropriate or dangerous software to a computer. Storing bootlegged software can expose a company to copyright infringement claims. Computer games often reduce employee productivity. If imported onto a computer system, computer pornography may create a hostile work environment that leads to a sexual discrimination lawsuit against the company. Computer viruses can cause the loss of critical information stored on a computer. Finally, the computing system itself may be damaged or otherwise misconfigured when left accessible to technically oriented employees who take it upon themselves to attempt to repair and/or modify the computer system. Similarly, networked systems may be vulnerable to pernicious software, such as viruses, worms, “Trojan horse” programs, etc., as well as illegitimate intrusions by hostile users, e.g., computer “crackers” or “hackers”, for purposes of espionage, theft, or vandalism.

Another concern often raised in connection with the present practice of placing the computer system at the desktop is that such workstation designs actual work against proper maintenance of the computing system. When placed underneath the desktop, computing systems are often forced to absorb physical shocks when accidentally kicked, knocked over or struck by falling objects, any of which could result in damage to the various electronic components, located within the chassis, including the computing system. Oftentimes, a computing system is placed in a “convenient” location and not in a location designed to keep it cool. A computer system typically includes a cyclonic fan designed to direct a constant flow of cooling area at the heat-generating components of the computing system. However, if a barrier is placed a few inches in front of the fan intake, the efficiency of the fan is reduced dramatically. Similarly, placing the computer system against a wall or running cables in front of the fan adversely affects the ability of the fan to properly cool the computing system. Finally, even in relatively clean office environments, the fan tends to draw in dirt and other dust particles into the interior of the computer chassis where they are deposited on the heat-generating electronic components which include the computing system. As dust tends to collect on and insulate the components on which it is deposited, the ability of such components to dissipate heat becomes degraded.

Logistical support, too, becomes a vexing problem for computer-intensive organizations when computing systems are scattered throughout a facility. When machine failures occur, the repair person must go to the machine to diagnose and repair the machine. Oftentimes, this entails multiple visits to the machine's location, particularly when the first examination reveals that replacement parts or a replacement machine are needed. Similarly, software upgrades and other performance checks become quite time-consuming tasks when personnel must travel to each machine where the software resides locally.

Finally, many office buildings were designed before the advent of the age of the personal computer (PC). As a single PC can consume over 300 watts of power, a heavily computerized workplace could potentially demand power in excess of the amount available. Similarly, the heat generated by the large number of computers installed in modern workplaces can easily overwhelm the air conditioning capacity of a building's HVAC system, thereby causing room temperatures to rise above those levels preferred by the occupants of the building.

Prior art approaches to addressing some of the issues described above include so-called “thin-client” systems, and “remote” computing systems, where, for example, a user interacts with a computing resource, such as an application server or workstation, via a human interface implemented or mediated by a platform with reduced computational resources, e.g., a thin-client or so-called “zero-client” device, that relies on networked resources to provide some or all computational functionality of the user. However, current state-of-the-art ‘thin client’ or ‘remote’-type computing offers a simplistic user experience and is limited as to the computational horsepower that can be employed by the user. Further the prior art is severely bounded as to the applications that can run intrinsically, requires considerable maintenance and thus has high support costs and personnel requirements, operates according to an expensive business model, and is generally inadequate, as described below.

As indicated above, prior art approaches and systems falls into two classes: thin client, and remote desktop protocols.

The thin client approach relies on the use of a server to simulate or “virtualize” PC operations, as well as a (functionally) small “PC” (client) at the desktop to provide the user experience, where the client communicates with the server via a connection over the network or Internet. Typically this approach anticipates that the server hosts several users, which each utilize a respective thin client, also referred to as a “network computer” (NC). While various NC designs have been proposed, most entail removal of the auxiliary memory (also known as the hard drive) and substantially reducing the size of the processor. In most NC approaches, all software applications and data files are stored on the network and the NC is limited to accesses of network software and data files. Most NC designs also propose that all disk drives (typically, the CD and floppy drives) be removed, thereby eliminating the ability of the NC user to import or export software applications and/or data files.

The development of the NC is in part due to a recognition by the computer industry of security and other problems which have arisen due to the evolution of computer networks into their present configuration. However, the NC is not a fully satisfactory solution to these problems. While removing much of the processing capability from the workstation, most NC designs propose leaving sufficient intelligence (including a processor and memory) at the workstation to access the Internet, e.g., by executing web browser software, load software applications retrieved from the network memory, and perform other operations. Thus, while reduced in complexity, NCs will still have maintenance, power and cooling concerns. Thus, while the NC represents a step in the right direction, many of the aforementioned issues cannot be resolved by wide-scale implementation of NCs. Examples of such systems are provided by Sun Microsystems, Inc., and Citrix. FIG. 1, described below is an illustration of an exemplary Sun Microsystems solution, according to the prior art.

As FIG. 1 shows, in this system, a server, e.g., Sun's Sun Ray Enterprise Server running under the Solaris OS, includes various software applications, e.g., Solaris applications, that interact with an NC, e.g., a Sun Ray Enterprise Appliance, via an X11 server (which includes a virtual display device driver, as shown), as well as a virtual audio device driver. Note that this system also includes a virtual frame buffer, and a virtual audio device.

As FIG. 1 also shows, the client, i.e., the Enterprise Appliance, includes an audio device, a display, a keyboard, and a mouse, i.e., various user interface devices, whereby the user may interact with the server (e.g., applications executing on the server). Note that these interface devices use various device drivers, also included on the client device, e.g., in firmware, such as an audio device driver, and a display device driver. As shown, the keyboard and mouse may utilize a USB device driver.

Note that the user interface devices communicate with the server side drivers via a special proprietary protocol, specifically, the Hot Desk Technology Protocol, provided by Sun Microsystems, Inc.

FIG. 2 illustrates a prior art remote desktop protocol approach. In this approach, remote control techniques permit one personal computer to ‘take over’ the desktop of another personal computer (the host computer) through a network and thus operate the host computer at a distance. A Microsoft-based technology implemented as Windows NT Terminal Server™ and Windows 2000/2003 Terminal Services™, and manifested in Windows XP Professional™, the technology permits one user to run a session on another user's machine.

As FIG. 2 shows, a terminal services capable server computer couples to a client computer system running remote desktop protocol (RDP) client software. A user of the client system utilizes the RDP to conduct a remote session on the server system, whereby the user may access various resources included on the server.

Note that in both of these prior art approaches, the hardware becomes a bottleneck in the delivery of the user experience. For example, in the case of the server based computing model the need to share the server with other users typically reduces the complexity of the work that can be done and the associated experience that can be had by the user.

In order to fully resolve the aforementioned issues, in some current systems the entire computing system is physically separated from the human interface, specifically, by keeping the human interface (display, keyboard, mouse and printer) at the desktop or workstation while relocating the associated computing system (e.g., motherboard, power supply, memory, disk drives, etc.) to a secured computer room where plural computing systems are maintained. By securing the computing systems in one room, the employer's control over the computer systems is greatly enhanced. For example, since employees no longer have personal access, through the floppy or CD drive, to the memory subsystem, employees can not surreptitiously remove information from their computing system in this manner. Nor can the employee independently load software or other data files onto their computing system. Similarly, the employee can no longer physically change settings or otherwise modify the hardware portion of the computer. Maintenance is also greatly facilitated by placement of all of the computing systems in a common room. For example, the repair technicians and their equipment can be stationed in the same room with all of the computing systems. Thus, a technician could replace failed components or even swap out the entire unit without making repeated trips to the location of the malfunctioning machine. Such a room can be provided with special HVAC and power systems to ensure that the room is kept clean, cool and fully powered.

U.S. Pat. No. 6,012,101 titled “Computer Network Having Commonly Located Computer Systems”; U.S. Pat. No. 6,119,146 titled “Computer Network Having Multiple Remotely Located Human Interfaces Sharing a Common Computing System”; U.S. Pat. No. 6,038,616 titled “Computer System With Remotely Located Interface Where Signals are Encoded at the Computer System, Transferred Through a 4-wire Cable, and Decoded at the Interface” disclose systems where a plurality of computing systems are located at one location, and the human interfaces associated with these computing systems are remotely located at respective desktops.

However, these systems rely on conversion of digital I/O signals to analog signals for transmission between the computing system and the human interface (and the corollary conversion back to digital I/O signals upon reception), which may significantly limit transmission distances, and may require complicated digital/analog signal manipulation with commensurate hardware complexity.

Another issue not addressed by prior art systems is the fact that most computers are typically not run at full capacity. In other words, the vast majority of computer systems remain idle for a great deal, if not most, of their operative lives. For example, typical tasks such as word processing, email, and web browsing generally use only a fraction of the system's processing and storage capabilities. Generally, a user's computer system is geared for peak usage for that user, i.e., is equipped or configured to meet the demands of the user's most intensive applications. For all those times that the user is not running these intensive applications, the system is likely to be substantially underused. Thus, a large portion, if not all, of a company's information technology (IT) resources are under utilized, resulting in wasted expenses, and inefficient usage of computational resources and computing services.

Therefore, improved systems and methods are desired for providing computational resources and computing services to users.

### SUMMARY OF THE INVENTION

The present invention comprises various embodiments of a system for providing computational resources and computing services, e.g., to a home or office. The system may be described as a distributed computing system that may operate to connect users to computing resources over a network so as to offer the greatest possible choice of compute resources and highest fulfillment of the user computing experience. Embodiments may provide a new computing platform and model, based on the separation of the human interface devices, which are positioned locally to the user, and computing resources, that may be used on an as needed basis.

The system may include one or more user interface systems, each including a plurality of human interface devices (HIDs). The system may also include a human interface intermediary (HII) that interfaces between the HIDs and a network. The HID is coupled over a network, e.g., the Internet, to a plurality of computing resources, e.g., network connected computing devices. The system may also include at least one computing resource that comprises resource and session management software, which may be referred to herein as a “resource intermediary” or “interlocutor”.

The HII may facilitate operation of the HIDs for the user and transmission/receipt of human interface signals over a network. The HII may operate to receive human interface signals input by the user, e.g., mouse signals, keyboard signals, speech, etc., and packetize or otherwise encode this data for transmission on the network. The resource intermediary receives this user input data and is responsible for identifying appropriate computing resources to perform tasks specified by the user. The computing resources may perform tasks requested by the user and generate resultant output signals, such as output video and audio signals.

The HII may operate to receive incoming human interface signals (packetized and/or encoded) intended for output human interface devices and generate appropriate human interface signals to output human interface device, e.g., a display and speakers. For example, the HII may receive packetized video/graphics signals and in turn generate video signals used to refresh a display. The HII may also receive packets of (optionally encoded) audio signals and generate audio signals for driving speakers.

Thus, various embodiments of the present invention may provide means for providing computing resources to a user over a network. The system may support a more efficient computing model that allows computing resources to be used by a plurality of different users on an as needed basis.

### BRIEF DESCRIPTION OF THE DRAWINGS

Other advantages and details of the invention will become apparent upon reading the following detailed description and upon reference to the accompanying drawings in which:

FIG. 1 illustrates a thin client system, according to the prior art;

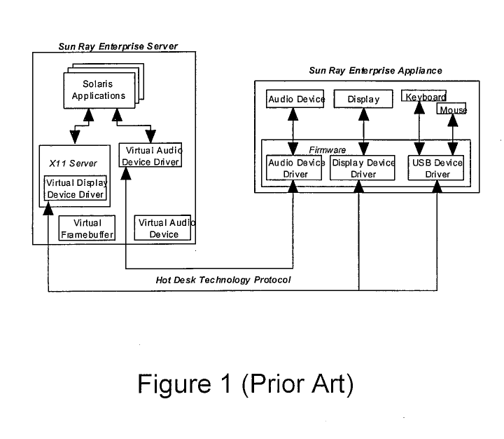

FIG. 2 illustrates a remote desktop system, according to the prior art;

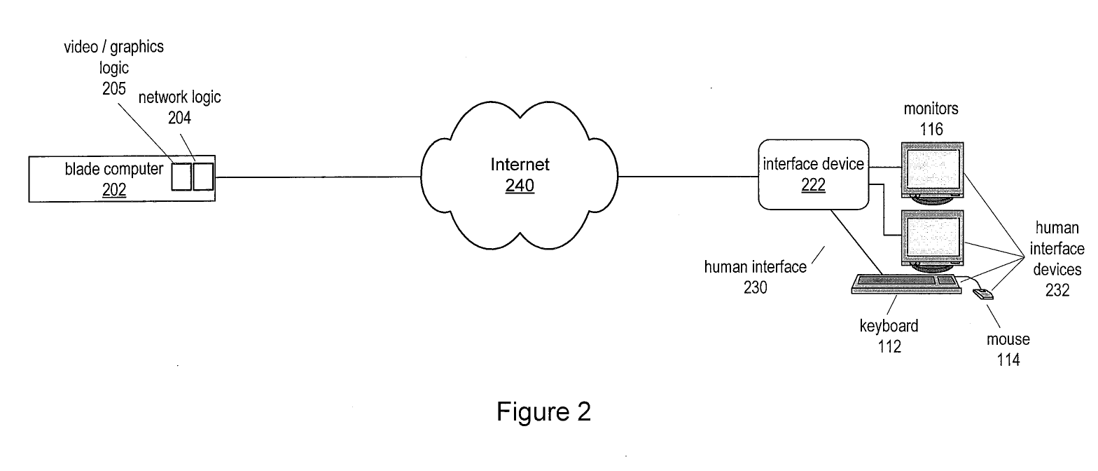

FIG. 3 is a high-level diagram of a distributed computing system, according to one embodiment;

FIGS. 4A and 4B are high-level diagrams of further embodiments of the present invention;

FIG. 5 is a high-level flowchart diagram illustrating a method for providing computing resources to a user, according to one embodiment;

FIGS. 6A-6C are flowchart diagrams of more detailed embodiments of the method of FIG. 5;

FIGS. 7A-7C are high-level diagrams illustrating communication flow in exemplary dual network, multiple human interface intermediary, multiple I-resource embodiments of the present invention; and

FIG. 7D is a high-level diagram illustrating communication flow in an exemplary multiple network, multiple human interface intermediary, multiple I-resource embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

Incorporation by Reference

The following patents and publications are hereby incorporated by reference in their entirety as though fully and completely set forth herein.

U.S. Pat. No. 6,119,146 titled “Computer Network Having Multiple Remotely Located Human Interfaces Sharing A Common Computing System”, which was filed May 4, 1998, whose inventors are Barry Thornton, Andrew Heller, Daniel Barrett, and Charles Ely.

U.S. Pat. No. 6,038,616 titled “Computer System With Remotely Located Interface Where Signals Are Encoded At The Computer System, Transferred Through A 4-Wire Cable, And Decoded At The Interface”, which was filed May 4, 1998, whose inventors are Barry Thornton, Andrew Heller, Daniel Barrett, and Charles Ely.

U.S. Pat. No. 6,012,101 titled “Computer Network Having Commonly Located Computing Systems”, which was filed May 4, 1998, whose inventors are Andrew Heller, Barry Thornton, Daniel Barrett, and Charles Ely.

U.S. patent application Ser. No. 10/032,325 titled “System And Method For Remote Monitoring And Operation Of Personal Computers”, which was filed Dec. 31, 2001, whose inventors are Ronald J. Perholtz and Eric J. Elmquest.

U.S. patent application Ser. No. 09/728,667 titled “Computer on a Card with a Remote Human Interface”, filed Dec. 1, 2000, whose inventors are Andrew Heller and Barry Thornton.

U.S. patent application Ser. No. 09/728,669 titled “A System of Co-Located Computers in a Framework Including Removable Function Modules for Adding Modular Functionality”, filed Dec. 1, 2000, whose inventor is Barry Thornton.

U.S. Provisional Patent Application Ser. No. 60/720,267 titled “Amorphic Computing”, filed Sep. 23, 2005, whose inventor is Barry Thornton.

U.S. Provisional Patent Application Ser. No. 60/720,295 titled “Distributed Computing System”, filed Sep. 23, 2005, whose inventor is Barry Thornton.

Terms

client/server system—a system that includes a server computer that stores application software, coupled to one or more client computers over a network, where each client computer sends requests for application services to the server computer over the network, which downloads the appropriate application software and/or data to the client computer over the network.

utility computing—a computation model where a user is provided with human interface devices (e.g., mouse, monitor keyboard, printer, etc.) at some distance from a pool of networked computing resources (including hardware and/or software resources). The computing resources may be provided to the user on an “as needed” basis. A fee may also optionally be charged for use of the computing resources.

back-end—the hardware, software, maintenance, and process that deliver utility computing to the distal user upon demand.

front-end—the various hardware components (and optionally, software) that constitute a human interface for interacting with the back-end for utility computing functionality.

user's computing experience—the nature and level of man-machine interaction; the quality, quantity, and expediency of the interaction; the user's experience mediated by the front-end or human interface.

resource intermediary—software (as well as a computer system that executes this software) that acts as an intermediary between human interface devices operated by a user at a first location and computing resources at a second different location. The term “resource intermediary” may generally refer to a computing resource/session management software that operates to manage back-end operations in a utility computing system, and communicate I/O signals accordingly with the front-end, i.e., with the user interface; may also refer collectively to the management software and the computing platform on which it executes (i.e., I-resource).

computing resource—any network accessible hardware and/or software usable to perform a task.

I-resource—a computing platform that executes computing resource/session management software (resource intermediary) to manage and conduct utility computing sessions for a user.

session—a use of a computing resource to perform a specified task. The use may be invoked by a resource intermediary, specifically, at the request of a user via a human interface intermediary.

human interface intermediary (HII)—a network-capable device that facilitates communications between a human interface (e.g., including a plurality of human interface devices, e.g., keyboard, monitor, mouse, speakers, microphones, etc.) and another device, such as a computing resource, that is located remotely (greater than 10 feet) from the human interface. An HII may be a device that facilitates communications between a human interface and a resource intermediary program executing on an I-resource for utility computing. The HII and the resource intermediary may conjunctively communicate with the human interface in accordance with the attributes or constraints of the human interface devices.

One object of the present invention is to provide a utility-computing back-end that efficiently and automatically deploys and uses distributed networked computing resources to optimize the user's computing experience in performance of a task, based on the attributes of the front-end or human interface. In other words, various embodiments of the present invention may allow seamless provision of heterogeneous computing resources, including multiple operating systems, hardware resources, etc., to a user in accordance with the capabilities of the user's particular human interface devices, thus abstracting the computing resources and the interface for utilizing such resources. Such functionality may be referred to as “amorphic computing”. It should be noted that the system described herein is not a client/server system, which, as defined above, includes a server computer that stores application software, coupled to one or more client computers over a network, where each client computer sends requests for application services over the network from the server computer, which downloads the appropriate application software and/or data to the client computer over the network. In the present invention, the user interacts with a computing system via a remote human interface that is not itself a computer, i.e., as opposed to using a client computer system. Thus, according to the present invention, the server that is accessed over the network executes the application software and provides results of this execution to the user over the network via the remote human interface.

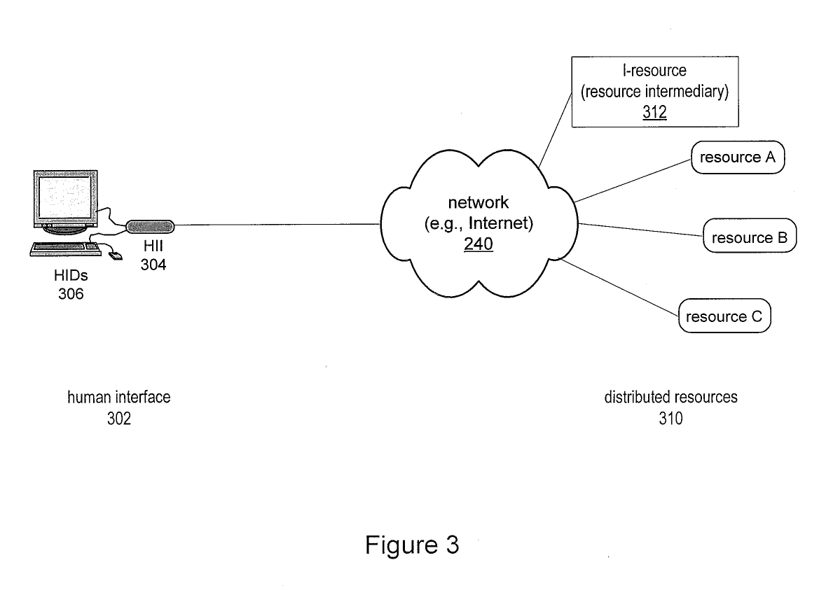

FIG. 3—A Distributed Computing System

FIG. 3 illustrates a distributed computing system, according to one embodiment of the invention. More specifically, various embodiments of the system shown in FIG. 3 may operate to connect users to computing resources over a network so as to offer the greatest possible choice of compute resources and highest fulfillment of the user computing experience. Note that as used herein, the term “computing resource” may refer to any hardware and/or software that is accessible over a network, and usable to perform a task.

As FIG. 3 indicates, the system may include one or more user interfaces, each including a plurality of human interface devices (HIDs) 306. The system may also include a human interface intermediary (HII) 304, described in more detail below, coupled over a network 240, e.g., the Internet, to a plurality of computing resources 310, e.g., resource A, resource B, and resource C, etc., e.g., network connected computing devices. The system may also include at least one computing resource that comprises resource and session management software, which may be referred to herein as a “resource intermediary” or “interlocutor”.

Each human interface 302 may include any of a variety of HIDs 306. Examples of HIDs include, but are not limited to, computer displays, i.e., monitors, virtual reality (VR) gear, keyboards, pointing devices, e.g., mouse, trackball, motion sensors, etc., speakers, microphones, cameras, force-feedback devices, card readers, and/or any other type of human interface device.

In preferred embodiments, the HII 304 may facilitate operation of the HIDs for the user and transmission/receipt of human interface signals over a network. The HII 304 may operate to receive human interface signals input by the user, e.g., mouse signals, keyboard signals, speech, etc., and packetize or otherwise encode this data for transmission on the network. The HII 304 may also operate to receive incoming human interface signals (packetized and/or encoded) intended for output human interface devices and generate appropriate human interface signals to an output human interface device. For example, the HII 304 may receive packetized video/graphics signals and in turn generate video signals used to refresh a display. The HII 304 may also receive packets of (optionally encoded) audio signals and generate audio signals for driving speakers.

The HII 304 is connected via the network 240 to the computer resource (e.g., computer) running the resource intermediary software, i.e., the resource intermediary or I-resource 312. Note that for brevity, this computer resource and the resource intermediary software (i.e., computing resource management software) may be referred to collectively as the resource intermediary or an “I-resource” 312. Once the HII 304 and the resource intermediary 312 are communicatively connected, the resource intermediary 312 may operate to run and manage session(s) for the user. The resource intermediary 312 may run and manage session(s) with selected computing resources 310 that accomplish tasks desired by the user. Note that in various embodiments, the session application software may be executed on the computer resource acting as the resource intermediary and/or other computer resources coupled to the network.

Note that any particular nomenclature used herein, such as “human interface intermediary”, “resource intermediary”, etc., is not intended to limit the components of the present invention to any particular functionality or form. Note further that while the embodiment of FIG. 3 shows only a single human interface 302, in other embodiments, any number of human interfaces desired may be coupled to the network.

Similarly, the computing resources 310 shown are meant to be exemplary only and are not intended to limit the resources provided for use by the user of the human interface(s) to any particular type or number of resources. Examples of computing resources 310 include, but are not limited to, computing systems, e.g., server computers, workstations, scanners, printers, plotters, or other types of display devices or arrays, FAX devices, sub-networks, storage devices, e.g., hard drives, disk arrays, cameras, control/automation systems, switching systems, networks, transmission media, etc. Computing resources also include software programs, e.g., software application programs and drivers such as word processing programs, spreadsheets programs, web browsers, email clients, analysis software, timekeeping software, accounting software, and any other various types of software. Computing resources 310 may also include data files, e.g., documents, audio/video files, configuration files, etc., among others; i.e., any type of resource, e.g., device, peripheral, data, or application, that may be accessed or otherwise used over a computer network.

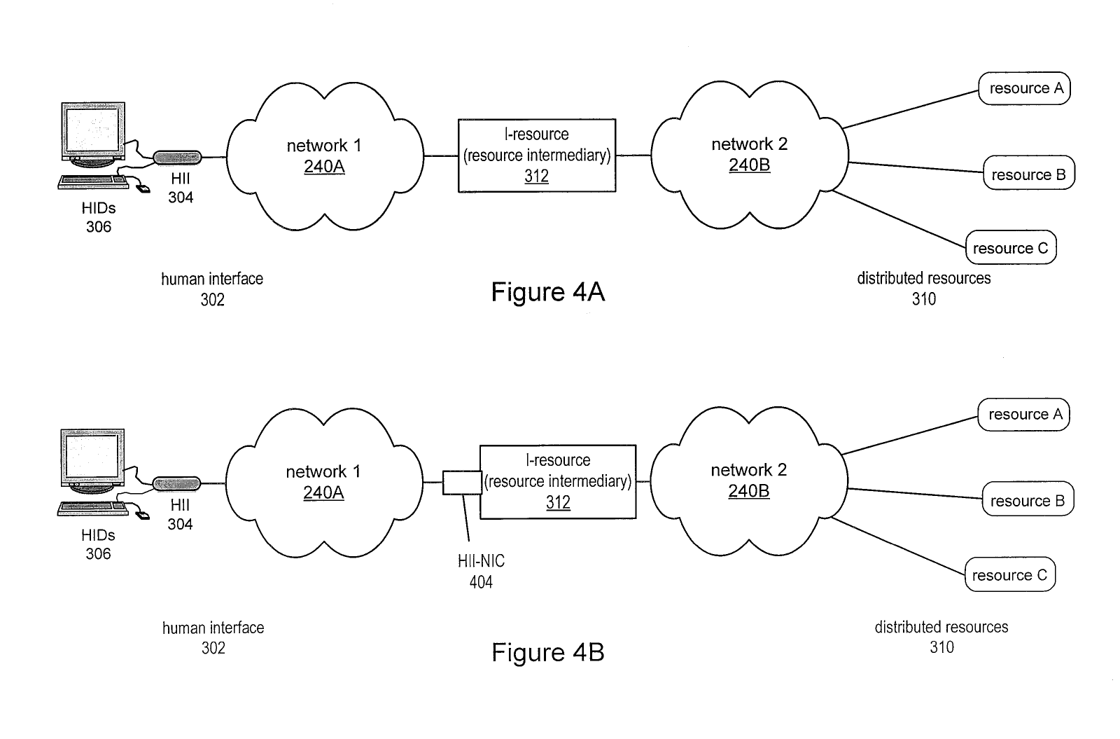

Thus, in a simple embodiment, a computing system comprising a HII with associated HIDs (on the left) may be connected to a network, e.g., a local area network (LAN), or a wide area network (WAN), such as the Internet. Computer resources (A, B, C, etc.) and at least one computing resource running the resource intermediary software may also be attached to the network. Several more complex embodiments are described below with reference to FIGS. 4A-4B.

FIGS. 4A-4B—Further Embodiments of a Distributed Computing System

FIGS. 4A-4B illustrate various further embodiments of the distributed computing system described above with reference to FIG. 3. These embodiments, and variants thereof, may enhance bandwidth usage and security of the system.

As FIG. 4A shows, in one embodiment, the human interface 302 (i.e., the HIDs 306 and HII 304) may couple to a first network 240A (network 1) through a HII 304. An I-resource 312 is coupled to the network 240A. The I-resource 312 is also coupled to a second network 240B, e.g., network 2, which in turn couples to various distributed resources 310, as shown. In other words, in some embodiments, the provision of distributed resources 310 may be facilitated via two network connections.

This dual network topology may improve bandwidth and security for the system by separating the network communication between the human interface 302 and the I-resource 312, from that between the I-resource 312 and the distributed resources 312. For example, as shown in FIG. 4B, in some embodiments, due to the limited syntax (e.g., command vocabulary) carried between the HII 304 and the resource intermediary 312, the information flow between the two may be hardware limited using a separate HII-NIC (Network Interface Card) to make the port ‘hack proof’. For example, this may provide absolute security to an ‘outside world’ network while keeping the “inside” network isolated and clean. Such a configuration may allow a mix of computer resources of different vulnerabilities, operating systems, and security levels, while maintaining necessary bandwidth and security.

FIG. 4C illustrates an embodiment where the resource intermediary 312 is integrated with the HII 304. The resource intermediary 312 may be placed at the same location as the HII 304, or the resource intermediary 312 and the HII 304 may comprise one device.

Resource Intermediary

The resource intermediary orchestrates the user computer experience aspects of the HII session. The resource intermediary 312 may run and manage session(s) with selected computing resources 310 that accomplish tasks desired by the user. Note that in various embodiments, the session application software may be executed on the computer resource acting as the resource intermediary and/or other computer resources coupled to the network.

The resource intermediary 312 may operate to receive human interface signals (input signals) from the user of the HIDs 306 and facilitate obtaining appropriate resources 310 to perform the tasks requested by the user. Thus, for example, if the user provides input requesting a word processing application, the resource intermediary 312 may locate a computing resource with the appropriate word processing application. if the user provides input selecting two or more different software applications, the resource intermediary 312 may locate one or more computing resources with the appropriate applications.

The resource intermediary 312 may operate to receive output video signals from each of the computing resources being used. The resource intermediary 312 may prepare the final screen image that the user will see, and package that image to best use the media and hardware connecting the HII user's eye and the resource intermediary. For example, based on information from the HII about the nature of the image display system and HIDs that the user is currently employing, the resource intermediary may take the various one or more screen images of the computing resource(s) currently being used and prepare them in the most presentable format for the user at that time. Note that the user may couple the resource intermediary 312 to, or attach the resource intermediary 312 on, any of a variety of different hardware platforms, e.g., wrist-watch PDA, cell phone, lap-top, desk-top, mobile, etc., at different times using different transmission media, e.g., wired, wireless, optical, acoustic, etc.). Thus, the resource intermediary 312 may operate to manage or organize HI signals mediating interactions between the user and the computer resources in a session.

In some embodiments, the resource intermediary 312 may accrue information about the user's past experiences (e.g., sessions) and may take this information into consideration during operation, such that the process may become heuristic in nature. For example, heuristics may be developed and used to make (automatic) subjective decisions about compression or processing techniques to be employed, screen sizing and intended (e.g., pleasing) distortions of the images presented, arrangement of icons on the desktop, etc.

In some embodiments, the resource intermediary 312, possibly in conjunction with the HII, may perform periodic or ongoing dynamic real-time network optimization to maintain efficient use of the network and its rules, including, for example, downloading of code or instructions to the HII to further facilitate overall video functionality and performance. As another example, the resource intermediary and/or the HII may monitor network performance, especially local throughput for the session, and may modify compression/transmission schemes for communication between the resources, resource intermediary, and/or HII.

The resource intermediary may also be operable to conduct remote sessions in other computer resources and orchestrate the passing of human interface device (HID) commands and video information to and from the various other computer resources. Note that the resource intermediary may run one or more sessions on other computer resources but may do so only via passing HID and video information between the HII and the one or more sessions, and thus the nature of the operating system on any other computer resource is not an issue. This aspect of the present invention may provide the capability to operate across various networks of differing security without actually interconnecting the networks themselves and thus maintain the veracity of the independent secured networks.

In some embodiments, the resource intermediary may be operable to determine and manage what other resources are needed to serve a user request for performing a task. For example, the resource intermediary may, upon the user's request (e.g., a screen icon or line prompt), locate an appropriate computer resource offering the processing and networking resources required to fulfill the task, and may make such a connection as part of session activation or configuration.

The resource intermediary may also decide the appropriateness of the request, validate the authority, implement and test the security rules, validate compliance requirements/fulfillments, and perform all other functions necessary for the satisfactory performance of the session for the user. Any failure to meet the requirements may cause the resource intermediary to gather data and/or request help, e.g., from a human operator.

In some embodiments, the resource intermediary may operate on a per user basis, i.e., each instance of the resource intermediary software may be dedicated to a particular user. For example, a user may initially register with a resource intermediary program or associated process, and a user profile may be established specifying that user's interface, e.g., what programs or tasks are available, look and feel of the GUI presented to the user, user's priority level, and/or any other information associated with the user that may be germane to conducting a network computing session with the user.

Alternatively, in other embodiments, a single profile may be defined for a plurality of users. For example, a standard profile may be defined for all users of a company or institution, or respective profiles may be defined for each of various groups of users, e.g., based on their responsibilities or privileges, and so forth. In some embodiments, there may be a default profile used by most users, but where custom or personal profiles may be defined as needed for select users, e.g., company officers, senior technical staff, etc.

Human Interface Intermediary

As described above, the human interface intermediary (HII) 304 may facilitate interactions between the user and the resource intermediary, providing interface functionality between the various HIDs included in the human interface 302 and the resource intermediary 312.

The HII 304 may be operable to initiate a network based session, e.g., at turn-on or user prompting, may activate a network based communications session with some other network attached computing resource hosting a resource intermediary, i.e., an I-resource. Note that the I-resource may be a server-like device or a specific set of addressed network resident devices (PC, network appliance, etc.).

The HII 304 may operate to send information to the resource intermediary that describes the nature of the human interface device(s) the user is using for the current session. Such information may include, but is not be limited to, device-specific attributes such as performance characteristics, as well as support for hand inputs (keyboards, pointing devices, etc.), vocal inputs and outputs, the display or imaging system, printers and/or other task specific hardware.

The HII may also be operable to download interface instructions and perform interfacing tasks, including, but not limited to, special keyboard “macros’ to operate special features, unique tablet and drawing pad feature enhancements, image rebuilding to meet local monitor or screen resolution and size constraints, color correction, screen rotation, etc. In some embodiments, the HII may be operable to assess the various attributes of the HIDs and automatically limit interface functionality accordingly. For example, the HII may construct and present a reduced graphical user interface on a PDA or cellular telephone compared to that presented on a keyboard/video/mouse (KVM) based system.

The HII is preferably immune to or protected from pernicious software or hostile users. For example, in some embodiments, the HII may implement a state-machine, treating downloaded code as bounded function sets which cannot independently interact. In other words, the HII may be operable to functionally and communicatively isolate downloaded programs to prevent illegitimate or destructive behavior, actions, and access.

The communications between the resource intermediary and the HII may comprise a bounded set of data transfers and command structures. For example, the information communicated may comprise bulk video/audio and print data from the resource intermediary to the HII, and may comprise mouse/keyboard communicated as controlled bulk data from the HII to the resource intermediary.

During operation when computing resources are being used, the HII 304 may operate to receive human interface signals input by the user, e.g., mouse signals, keyboard signals, speech, etc., and packetize or otherwise encode this data for transmission on the network. The HII 304 may also operate to receive incoming human interface signals (packetized and/or encoded) intended for output human interface devices and generate appropriate human interface signals to an output human interface device. For example, the HII 304 may receive packetized video/graphics signals and in turn generate video signals used to refresh a display. The HII 304 may also receive packets of (optionally encoded) audio signals and generate audio signals for driving speakers.

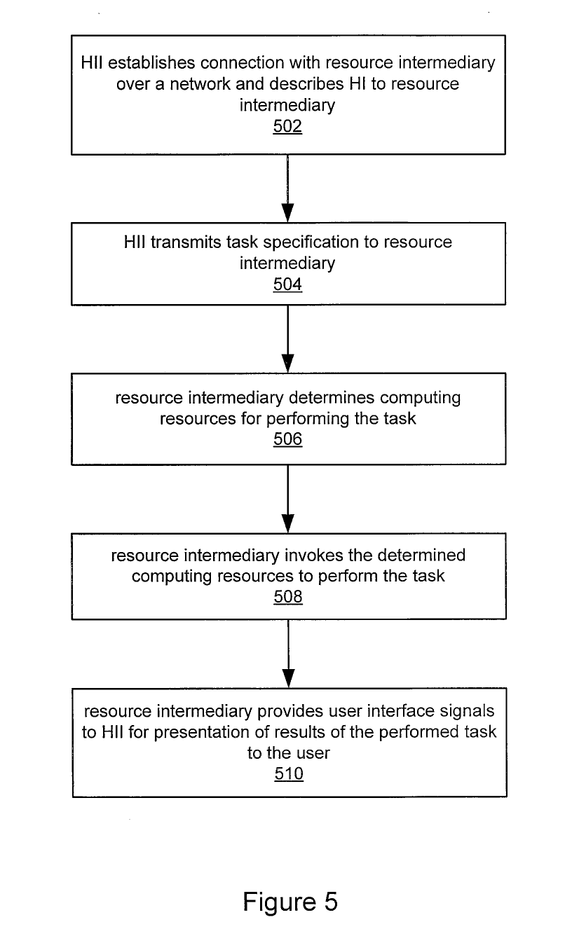

FIG. 5—High-Level Flowchart Diagram of a Method for Providing Distributed Computing Resources to a User

FIG. 5 is a high-level flowchart diagram of a method for providing distributed computing resources to a user, according to one embodiment of the present invention. It should be noted that in various embodiments of the methods described herein, some of the method elements may be performed concurrently, in a different order than shown, or omitted. Additional method elements may also be performed as desired. As shown, the method of FIG. 5 may be performed as follows:

In 502, a first device, e.g., a human interface intermediary or HII, coupled to a plurality of human interface devices, may establish a connection with a second device, e.g., an I-resource hosting resource intermediary software, over a network.

The second device preferably includes a processor, and a memory coupled to the processor, where the memory stores resource/session management software, i.e., a resource intermediary program, which is executable by the processor to conduct or manage network computing sessions, described below in detail.

In 504, in response to first user input specifying a task to be performed, the first device may provide first user interface signals generated by the plurality of human interface devices to the second device, e.g., to the resource/session management software, where the user interface signals include specification of the task. Said another way, the user may specify a task to be performed via user input to the first device through one or more of the human interface devices, and the second device may send corresponding (first) user interface signals specifying the task to the second device over the network.

In 506, the second device (as a resource intermediary) may determine one or more of the plurality of computing resources that are operable to perform the specified task, e.g., may determine a solution for performing the task. In other words, based on the received task specification, the second device, i.e., the resource intermediary, may make a determination as to what computing resources would be able to perform the specified task. For example, in one embodiment, the second device may query the computing resources as to their respective capabilities, e.g., available CPU cycles, storage, I/O bandwidth, application software, etc., and determine what resources have at least the minimum capability to perform the task. Alternatively, or in addition, such (resource capability) information may be (e.g., previously) collected and stored, e.g., in a database, that may then be queried by the second device to obtain the information. In various embodiments, the database may be stored on the first device, one of the computer resources, or the second device.

In 508, the determined solution for performing the task may be implemented, i.e., the specified task may be performed. More specifically, the second device, i.e., the resource intermediary, may invoke the determined one or more computing resources, possibly including the second device, to perform the specified task. Said another way, the second device/resource intermediary (e.g., executing the resource/session management software) may establish and conduct a network computing session with the determined computing resource(s) or device(s) to perform the specified task.

Finally, in 510 the second device/resource intermediary may provide second user interface signals to the first device, where the second user interface signals include results of the performance of the specified task, e.g., for presentation to the user via the human interface devices, e.g., the GUI, speakers, etc., as appropriate. In other words, once the task has been performed by the determined computing resources (as managed by the second device/resource intermediary), the resource intermediary may send (second) user interface signals that communicate results from the task to the first device, which may then present the signals, including the task results, to the user via one or more of the human interface devices. For example, in a simple example where the user has specified a task of factoring a large number, the second user interface signals may include image data for displaying a list of the computed factors of the number that may then be displayed to the user via a computer monitor.

These user interface signals may be specifically directed for presentation on or by the particular human interface devices coupled to the first device. For example, following the above factoring task example, consider a display device (one of the HIDS) that has a low resolution. In this case, the (second) user interface signals provided by the second device may be customized for this low resolution so that, for example, the list of factors displayed will be legible to the user. As another example, consider a case where the only display device of the HIDs is a printer—in this case the second device may generate or provide (second) user interface signals suitable for rendering by the printer. Of course, these are but two simple examples of such customization, and it should be noted that such customization of user interface signals may be used as appropriate for any particular set of HIDs desired.

Describing the above in a slightly different way, one function of the first device is to provide a communication interface between the human interface (devices) and the resource intermediary, specifically, in support of a network computing session. Thus, the first device is preferably operable to receive second user interface signals from the second device, and provide the second user interface signals to one or more of the plurality of human interface devices. For example, images, e.g., video images, may be provided to a monitor for display, sounds, e.g., voice, music, etc., may be provided to a speaker (or multiple speakers), and so forth. Conversely, as noted above, the first device is also preferably operable to receive human interface signals from at least a subset of the plurality of human interface devices, e.g., in response to user input to the devices, and provide the human interface signals to the resource intermediary executing on the second device, which may then operate accordingly.

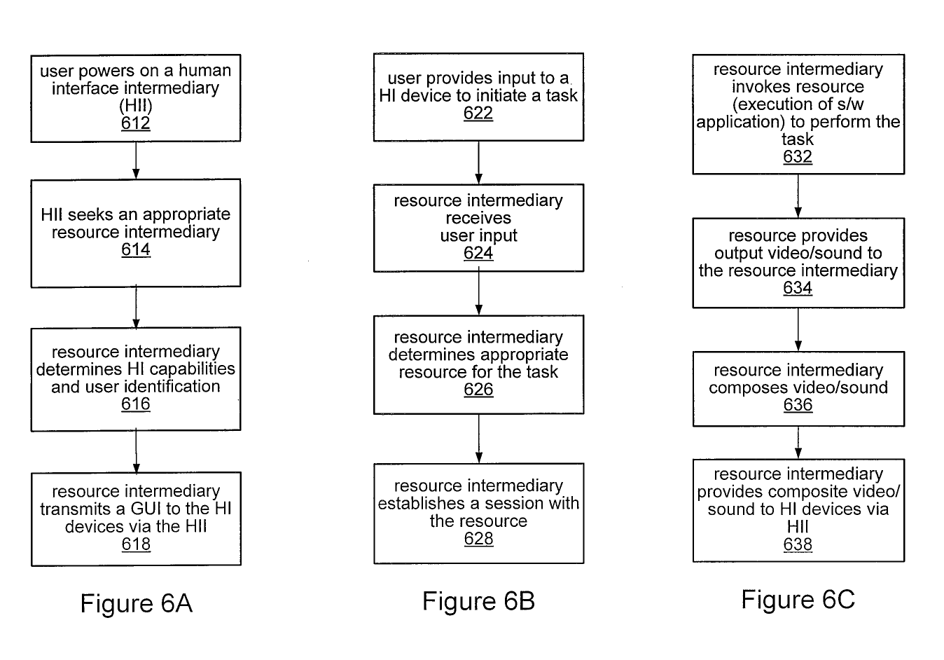

FIGS. 6A-6C—Detailed Flowchart Diagrams of Embodiments of a Method for Providing Computing Resources to a User

FIGS. 6A-6C are more detailed flowchart diagrams of embodiments of the method described above with reference to FIG. 5. As noted above, in various embodiments, some of the method elements described below may be performed concurrently, in a different order than shown, or omitted. Additional method elements may also be performed as desired.

FIG. 6A—Flowchart Diagram of a Method for Establishing Communications Between a User and a Resource Intermediary

FIG. 6A is a flowchart diagram of a method for establishing communications between a user and a resource intermediary, e.g., an I-resource running computing resource/session management software, according to one embodiment. The method may operate as follows:

In 612, a user may power on or otherwise provide input to a human interface. For example, the user may power on a human interface intermediary (HII) or a human interface device. The user may activate the HII (i.e., the above-described first device) in any of various ways. For example, the user may press a button on the HII or one of the human interface devices. As another example, the user may have a wireless transmitter that activates the HII when the user is in proximity with the HII.

In 614, the HII may seek an appropriate resource intermediary. As noted above, the second device or resource intermediary is preferably coupled to a plurality of computing resources, e.g., one or more computing systems, one or more storage devices, one or more printers, one or more scanners, one or more cameras, one or more plotters, and/or one or more control/automation devices, switching systems, networks, transmission media, data files, e.g., documents, configuration files, audio/video data, etc., among others. In one embodiment, the second device is coupled to the plurality of computing resources over the first network. In other embodiments, the second device may be coupled to the plurality of computing resources over a second network. In yet further embodiments, the second device may be coupled to the plurality of computing resources over a plurality of networks, e.g., over the Internet.

In one embodiment, the HII may be configured with a static IP address of a respective resource intermediary, or DHCP may be used to provide the IP address. In another embodiment, the HII may perform a network search to locate the appropriate resource intermediary based on any of various criteria, and establish a network connection to the resource intermediary/I-resource.

In one embodiment, each resource intermediary may maintain a database (or equivalent) of computing resources available or accessible by that resource intermediary. In another embodiment, a database may be located on the network that contains information on various computing resources, and each resource intermediary is operable to access this database to determine appropriate computing resources to accomplish tasks specified by the user (e.g., as the result of a query from seeking HIIs). The database may store the types and locations (e.g., IP addresses) of computing resources, e.g., performance related attributes of the resource intermediary, such as latency, bandwidth, cost, etc., which may be based on location, e.g., physical proximity, network topology, I-resource processing power, etc., which may be used to inform the HII. In other embodiments, the HII may use any other criteria germane to the provision of computing resources to the user. Thus, the HII may consider various resource intermediaries available over the network, and may select one based on one or more criteria.

In one embodiment, the resource intermediary selects an appropriate computing resource from among a plurality of possible computing resources based on cost (in monetary terms) as well as other possible factors such as latency, etc. For example, the resource intermediary may query a plurality of possible computing resources to determine their respective costs, and then use the computing resource that is at the lowest cost. The resource intermediary may solicit bids for the lowest cost computing resource, and then establish a session with the lowest cost computing resource.

In 616, the resource intermediary may determine human interface (HI) capabilities of the user's human interface, and the user's identification (ID). For example, upon activation the resource intermediary may query the human interface devices, e.g., via the HII, to determine the types of devices present, e.g., the type of display, whether a printer is available, whether speakers are available, the types of input devices, e.g., whether a pointing device, e.g., a mouse/trackball is available. For example, the information may include display resolution/refresh rate, capabilities of various devices, and so forth. In other words, the resource intermediary may characterize the HI in order to properly communicate with the user via the HI.

The HII may send information describing at least a subset of the plurality of human interface devices to the resource intermediary (second device), e.g., in response to user input to one of the human interface devices, and/or in response to a query from the resource intermediary. The information describing at least a subset of the plurality of human interface devices may include performance characteristics of the plurality of human interface devices, and/or I/O capabilities of the devices, among other attributes of the human interface.

In some embodiments, in response to the information describing at least a subset of the plurality of human interface devices to the second device, the second device may provide interface instructions specifying operation of one or more of the plurality of human interface devices. In other words, the first device may download the interface instructions specifying operation of one or more of the plurality of human interface devices. The first device may then operate the various human interface devices in accordance with the interface instructions.

In one embodiment, the resource intermediary may store information regarding desired human interface configuration options of the specific user, e.g., how the display should be configured, what screen resolution to use, the icons that should be displayed and their presentation on the display, and other personalized human interface settings or parameters.

In another embodiment, the user may provide identification information indicating the identity of the user, e.g., through a user name and password, a wireless transmitter, fingerprint, voice recognition, retinal scan, etc. The resource intermediary may then use the identification information to obtain human interface configuration information, e.g., from a database located on the network. Thus in this embodiment each of a plurality of HIIs may be substantially identical, i.e., each HII may not be specific to an individual user. When a certain user approaches an HII and provides identification information, the HII may obtain HI configuration information specific to the user from a database and configure itself to control the various human interface devices accordingly. In one embodiment, the ID information may include auxiliary information used to denote a user or HI profile stored on the resource intermediary and/or accessible by the resource intermediary (e.g., stored in a database), whereby the resource intermediary may characterize the user's HI and/or configure itself for communications with the user.

As noted above, the HII is preferably coupled to a plurality of human interface devices (HIDs), e.g., keyboard, display, mouse, speakers, etc., and is further coupled to a network, e.g., a wide area network (WAN), such as the Internet, or a local area network (LAN), which may itself be coupled to a WAN.

In 618, the resource intermediary (second device) may transmit a graphical user interface (GUI) to the HI devices (e.g., via the HII). In other words, the resource intermediary may provide a user interface (GUI) to the HII (first device) for presentation to the user, e.g., on a computer display (monitor), whereby (in conjunction with one or more input devices) the user may interact with the resource intermediary. The appearance and functionality of the GUI may be at least partially determined based on the characterization of the HI and/or the user's profile information. Thus the GUI that is presented may be customized to the specific user.

In one embodiment, it may be desirable for an organization to transmit a consistent or identical GUI to all members of the organization. In this instance, the resource intermediary may not utilize any user ID or profile information to configure the human interface (e.g., the appearance of the display GUI), but rather may transmit the generic or common GUI to the HII for presentation to the user.

FIG. 6B—Flowchart Diagram of a Method for Establishing a Network Computing Session

FIG. 6B is a flowchart diagram of a method for establishing a network computing session, according to one embodiment. As described above, in preferred embodiments, a GUI is provided by the resource intermediary whereby the user may interact with the resource intermediary to establish a network computing session, as described below.

In 622, the user may provide input to a HI device to initiate a task. For example, the user may provide input to the GUI specifying the task to be performed. In various embodiments, this may include selecting from (and possibly modifying or configuring) a number of pre-defined tasks presented on the GUI (by the resource intermediary). For example, this may involve the user selecting an icon on the GUI which represents an application program, such as Microsoft Word™, Excel, etc. The user may provide other input to formally specify the task, e.g., via user-specification of particular applications to execute, and/or providing natural language descriptions of the desired functionality to be performed, among others.

Examples of tasks include, but are not limited to, execution of one or more applications, e.g., in batch or interactive mode, retrieval/storage/display/printing/transfer of documents, monitoring a networked system, e.g., viewing/controlling a webcam, analyzing data from a sensor, controlling a remote device, and so forth, or any other operation or process that may be invoked, controlled, or observed, over the network. It should be noted that a task may include anything from a simple command exchange or query, to complex and/or compound functions, possibly involving scripted execution of multiple applications according to specified dependencies or temporal schedules, including report generation, logging, monitoring, etc. Moreover, in some embodiments, tasks may include sub-tasks, and thus may comprise a hierarchy of tasks.

For example, if the user has specified a document-printing task, the resource intermediary may determine if the document is available for access, and if a suitable printer is available for printing the document. If either the document or the printer is unavailable, a message indicating such may be provided for display to the user (via the human interface).

In 624, the resource intermediary may receive the user input, or information regarding the user input, initiating or specifying the task. For example, where the user has selected a GUI element to start an application program, information regarding the application program may be provided, e.g., launch MS Word. In some embodiments, the resource intermediary may analyze the user input to determine the nature or requirements of the task. For example, in the case where the user input comprises a natural language description of the task, the user input may be parsed and analyzed by the resource intermediary, and the task specification formalize, e.g., put into a form useable by the resource intermediary.

In 626, the resource intermediary (second device) may determine an appropriate resource (or resources) for the task. The appropriate resource may be determined based on any of various criteria, such as, but not limited to, resource functionality, performance (including latency, bandwidth, etc.), cost, location, and so forth. Such criteria may be specified by the user as part of the task specification, may be included in a user's (or group's) profile, or may be specified as part of a more general infrastructure attribute, e.g., may be applied to everyone using the system.

As noted above, a database may be available on the network (e.g., on a LAN or on the Internet) that stores information regarding types and locations of computing resources. The resource intermediary may access this database to determine appropriate computing resources that are available. The resource intermediary may also analyze cost information and use this information in selecting computing resources.

In some embodiments, the resource intermediary may maintain, or have access to, a database of computing resources, which may be queried to determine the appropriate resources for the task. In one embodiment, the database may include task characterizations and information indicating various resources for performing each task, as well as descriptive information for the resources, e.g., vendor, cost, performance specifications, etc, which may then be used to find a most suitable match for the present task.

As noted above, various criteria may be used to determine the appropriate resource(s). For example, in one embodiment, the resource intermediary may conduct an online auction, whereby various vendors may compete, possibly via fully automated (reverse) bidding, to provide solutions (e.g., resources) for the task. The resource intermediary may then select the “winning” bidder, and propose the corresponding solution to the user, and/or may initiate the session, as described below.

Thus, various levels of selection criteria can be employed in the determination of which computer resources to employ, such as, for example, historic horsepower needs at the application level, whether that particular application is free on a resource (no concurrent use of applications), cost, schedule, etc.

In some embodiments, the resource intermediary may perform a discovery process to determine the plurality of computing resources coupled to the second device. If, for example, appropriate computing resources are not found on the network, a message indicating such may be presented to the user or to an IT manager. The user or IT manager may provide additional computing resources, e.g., by connecting one or more devices to the network, loading additional software onto existing computers in the network, etc. In one embodiment, the IT manager may modify the network (e.g., the “resource network”) to include one or more additional networks, thereby expanding the pool of computing resources available for use by the resource intermediary, after which, for example, the resource intermediary may perform another search for the appropriate resources.

Note that as used herein, the term “resource” may refer to a single resource, such as an application, or may refer to a plurality of resources. In other words, a resource may be compound, e.g., may include “sub-resources”. Thus, invocation of a resource may include invocation of sub-resources, and/or associated resources, e.g., sequentially, in parallel, hierarchically, and so forth.

Finally, in 628, the resource intermediary may establish a session with the determine resource. In other words, the resource intermediary may establish a network connection with the determined resource(s) (e.g., if not resident on the I-resource itself), and invoke use of the resource to perform the specified task, as described below in more detail.

FIG. 6C—Flowchart Diagram of a Method for Conducting a Network Computing Session

FIG. 6C is a flowchart diagram of a method for conducting a network computing session, according to one embodiment. The method may operate as follows:

In 632, the resource intermediary may invoke a resource to perform the specified task. For example, the resource intermediary may invoke execution of a software application on a computing device, e.g., on the I-resource hosting the resource intermediary, or on a computing device coupled to the I-resource over the network. In some embodiments, the application may be executed in a distributed manner, e.g., may be executed on a plurality of computing devices.

Note that depending on the nature of the requested resource and the task to be performed, the I-resource (resource intermediary) 312B may transfer a resource (e.g., by moving or copying a data file from one hardware resource to another), utilize the resource (e.g., storing a file, etc.), or may invoke the resource in situ (e.g., invoking execution of a program on a hardware resource coupled to the I-resource). In most, if not all, of the resource uses, some type of application or other software program will be executed to perform the task. For example, in the case of a file copy or transfer, some type of file management program must be invoked. Similarly, in the case of document preparation, execution of a work processor may be invoked.

In some embodiments, the resource intermediary may request confirmation from the user before performing the task. For example, in the document-printing case, the resource intermediary may present to the user, e.g., via the GUI, the determined solution to perform the task, i.e., an indication of the determined printer and document to be printed. The user may then confirm, thereby invoking the actual printing of the document, after which the resource intermediary may provide confirmation that the task has been completed successfully, or, if errors occurred, may indicate an error condition to the user. In other embodiments, the determined solution may be implemented automatically, i.e., without confirmation from the user. In one embodiment, the user human interface experience is no different than if the user was using a standard prior art computer system.

In 634, the invoked resource may provide output, e.g., video, sound, etc., to the resource intermediary, e.g., as a result of the resource invocation. For example, an executing software application may provide execution results to the resource intermediary, where the results may include batch results (i.e., final results of the application execution), interactive, intermediate, and/or ongoing results, e.g., streaming video or sound, as well as output for user interaction with the application, e.g., dialogs, user prompts, and so forth.

In 636, the resource intermediary may compose the output received from the resource in 634, e.g., in accordance with the capabilities of the HI, and optionally, the user's profile. For example, the resource intermediary may perform image processing on video data received from the resource to convert the video data to a form suitable for display on the user's HI, e.g., monitor, PDA, cellular telephone, etc. Similarly, if the HI has audio capabilities, the resource intermediary may similarly perform audio processing in accordance with these capabilities, e.g., stereo vs. mono sound, etc. Thus, the resource intermediary may generate composite HI data for presentation by the HI to the user. Where multiple different computing resources are used, and for example multiple video output signals are provided to the resource intermediary, the resource intermediary may operate to create a composite image of the multiple signals (or multiple windows) and provide this combined image to the HII.

As noted above, in one embodiment the user human interface experience is no different than if the user was using a standard prior art computer system, such as a standard prior art PC.

Finally, in 638, the resource intermediary may provide the composite HI data, e.g., composite video/sound, to the HI devices, e.g., via the HII. In other words, the resource intermediary may provide the composite HI data (which may include video data and/or sound, as well as any other HI data type supported and provided by one ore more computing resources) to the HII, which may then parse the HI data and provide various portions of the data to respective HI devices as appropriate. In preferred embodiments, the resource intermediary may compress the HI data prior to transmittal to the HII. The various HI devices may then present the output to the user, i.e., images may be presented on a display device (monitor, PDA screen, printer, etc.), sounds may be presented via speakers, headphones, etc., and so forth.

Note that the HII and resource intermediary may communicate repeatedly during the session. For example, if the task is interactive, the resource intermediary may mediate numerous exchanges between the user (via the HII) and the application performing the task, whereby the user provides input to the application as appropriate, and the application provides results, e.g., including any intermediate results, dialogs, etc., to the user (e.g., via the resource intermediary and HII).

It should be noted that in preferred embodiments, most or all communications between the HII and the resource intermediary are either user interface commands (HII to resource intermediary), e.g., keyboard/mouse input signals relaying user input to the resource intermediary; or video/audio output signals (resource intermediary to HII), for presenting information to the user, e.g., GUI, images, sounds, etc., via human interface devices, or other signals for controlling various human interface devices.

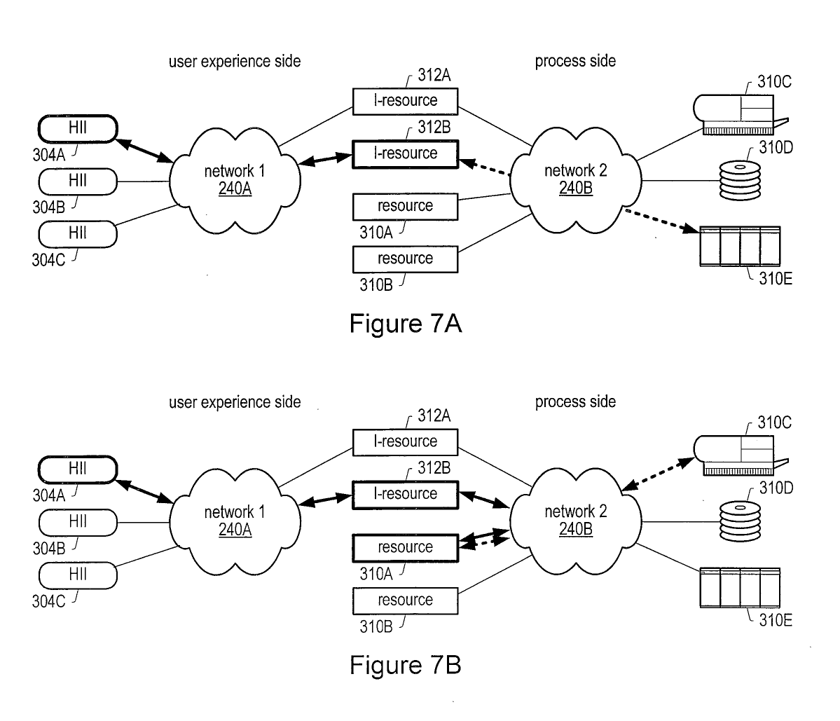

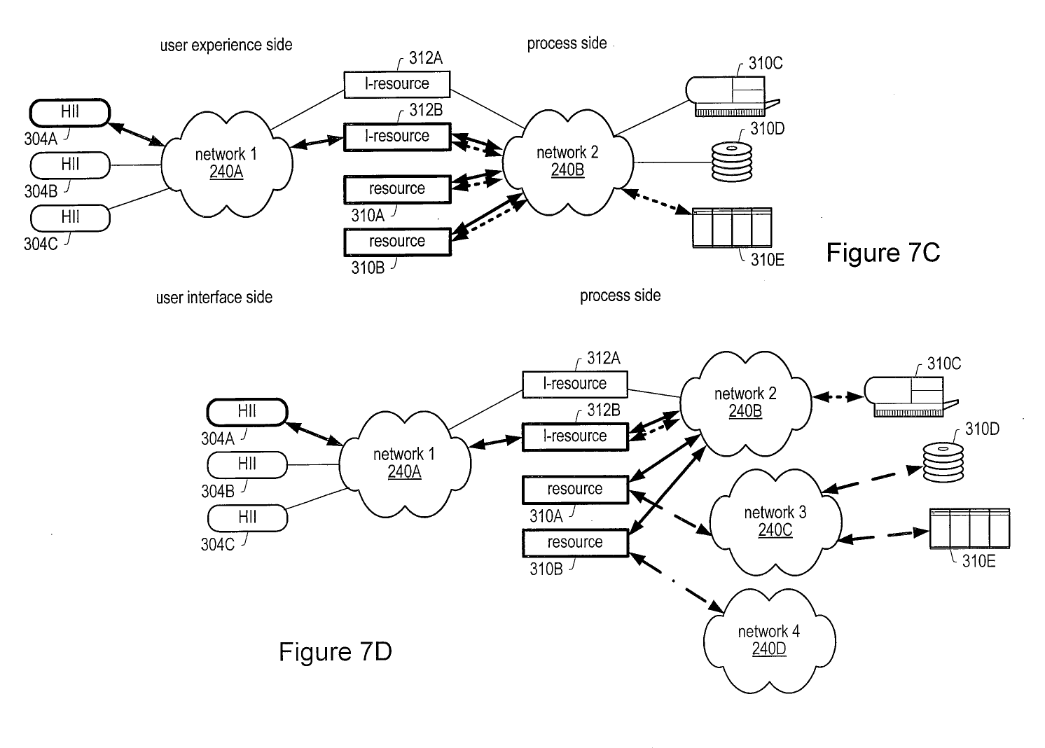

FIGS. 7A-7D—Further Embodiments of the Distributed Computing System

FIGS. 7A-7D are high-level diagrams illustrating aspects of the method of FIG. 5, according to various embodiments. Note that in the embodiments shown in FIGS. 7A-7D, a plurality of HIIs (human interface intermediaries, or functional equivalents), each of which is presumably coupled to a plurality of human interface devices (not shown), couple through a first network (network 1) to one or more of a plurality of I-resources hosting resource intermediary software (i.e., computing resource/session management software). Each I-resource is in turn coupled to a plurality of computing resources via a second network (network 2), and in the embodiment of FIG. 7D, a plurality of additional networks (networks 2, 3, and 4). As noted above, the computing resources may include any of: computing systems, e.g., servers, server arrays, printers, storage devices, switching systems, networks, transmission media, data files, e.g., documents, configuration files, audio/video data, etc., and/or any other type of computing resources, as desired. Each of FIGS. 7A-7D illustrates communication flow among various of the networked elements, corresponding to respective method elements of FIG. 5, described above, where the solid arrows/connections represent control and video data, which preferably comprises a bounded set of data and commands; and the short dashed, long dashed, and dot-dashed arrows/connections represent full bandwidth signals and vulnerable network data for respective networks.

As may be seen, each of FIGS. 7A-7D illustrates a respective embodiment of the present invention where one of a plurality of HIIs 304A (a first device of the method of FIG. 5) connects through a first network 240A (network 1) to one of a plurality of I-resources 312B, as indicated by double ended arrows connecting the HII 304A to network 1 240A, and network 1 240A to I-resource 312B (e.g., corresponding to method element 502 of FIG. 5), where the transmitted data comprise control and video data. The connected I-resource 312B (as well as the other I-resources 312) is in turn coupled to a plurality of resources 310 over a second network (network 2) 240B, where the transmitted data comprise full bandwidth signals. Note that in these embodiments, the resources shown include resources 310A and 310B, which may comprise individual computing systems (computers), as well as printer 310C, storage device 310D, and server array 310E, although it is note that these computing resources are meant to be exemplary only, and are not intended to limit the computing resources to any particular type or number.

In the example embodiment of FIG. 7A, the I-resource 312B then accesses a server 310 for a needed resource, e.g., in response to user input specifying a task to be performed (see method elements 504-508), as indicated by respective short dashed arrows connecting network 2 240B to the I-resource 312B, and server array 310E.

As noted above, in addition to invoking resources to perform a task, the I-resource/resource intermediary may also provide a GUI to the HII 304A for display by the corresponding human interface (e.g., monitor), where the GUI may be considered the user's primary screen for participating in the network computing session. Note that the resource intermediary may consider the I-resource on which it resides and executes to be just another resource available for performing tasks. For example, the I-resource may include various applications that may be invoked by the resource intermediary, just as applications on other resources may be invoked.

Thus, in some situations, the I-resource may run an application for the user as well as maintain the user's primary screen. For example, the I-resource may operate to perform an email or web related activity, as well as provide the interface for such activities to the user (via the HII and human interface devices). Note that in some embodiments, the resource intermediary may treat images originating from one computing resource as if they came from another computer resource. In other words, the particular location or source of accessed resources and their products, e.g., images, etc., may be hidden from the user, in accordance with the idea of abstracting the notions of computing resources, e.g., treating the collective resources as a single resource pool.

As noted above, the resource intermediary preferably isolates all image and HID data from the machine in which it resides, thus providing a powerful mechanism for maintaining security in and for the system. In other words, in preferred embodiments, communication between computers may be limited to human interface signals, e.g., images, sounds, and keyboard/mouse events.

Turning now to FIG. 7B, a more complex embodiment is illustrated. In this embodiment, the HII 304B communicates with the I-resource 312B (as above) and the I-resource communicates with another computing resource 310A; however, note that the information transmitted is limited to screen data and HID commands, as indicated by the solid arrows, which are not compatible with or usable by the other computing resources on the network. As also shown, data flow between the computing resource 310A and the printer 310C, as well as between network 2 and computer resource 310A, as indicated by the short-dashed arrows. Note that these data comprise full bandwidth signals, e.g., are not limited to video image data and commands, but may include any type of data required by or output by the resources.

The embodiment shown in FIG. 7C is slightly more complex. In this embodiment, multiple sessions are conducted utilizing different computer resources, e.g., I-resource 312B, resources 310A and 310B, as well as server array 310E. Moreover, these may be multiple sessions on each machine compounding the number of events occurring. Note that both of the computer resources (310A and 310B) are receiving HID commands from the I-resource 312B, which is typically running programs at the application level. As described above, the I-resource 312B preferably assembles a final image from all the imagery it receives from the two computer resources, which it may then transmit to the HII (see the description of FIG. 6C above). Note that the I-resource is also shown transferring standard network data, e.g., the I-resource may be providing email service to the user.

FIG. 7D illustrates an embodiment where additional networks (e.g., of computing resources) are included. More specifically, third and fourth networks are shown included (network 3 and network 4). In some embodiments, the various networks may have different security levels, and so it may be important to isolate access and (full bandwidth) communications with and within each network from the other networks. This partitioning of communication among the networks is illustrated by the various arrow types showing data flow in the system. For example, full bandwidth communications with network 2 are shown with short dashed arrows, as also shown in FIGS. 7A-7C, communications with network 3 are indicated with long dashed arrows, and those with network 4 are denoted with dot dashed arrows.

Note that from the user's viewpoint, the user has access to all the networks because that is what he sees on his screen; however, the actual data associated with each network never actually leave the computer resource on that network, since only video/sound (or other HI) data are being transmitted to the user. Thus, the various computer resources can be running different OS's, incompatible software, dated versions, etc., since only HI data, e.g., images and keyboard/mouse events, are actually transmitted between the machines, and thus, network security may be maintained naturally and transparently.

Thus, various embodiments of the present invention may facilitate provision of computing resources to users to perform specified tasks, where the resource intermediary orchestrates the activities of other computers at an application level to perform the tasks, and synthesizes a user's screen image from multiple application-level screens. Moreover, the system may operate across heterogeneous platforms and operating systems, as well as networks with different security levels and requirements, since communications between computers is performed at the application-HID level, e.g., images, mouse movements and keystrokes. Another benefit of this approach is that the communications process is restricted by its syntax such that it can not be “hacked’ or be subject to computer viruses or other network intrusion techniques. The user may thus be able to safely utilize or operate a variety of process that are not loaded in the resource intermediary device (computer), i.e., the second device.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

We claim:

1. A system for providing computer resources to users, the system comprising:
a first device coupled to a plurality of human interface devices, wherein the first device is operable to provide an interface between the plurality of human interface devices and a network; and
a second device coupled to the network;
wherein the first device is operable to:
establish a connection with the second device over the first network; and
in response to first user input specifying a task to be performed, provide first user interface signals generated by the plurality of human interface devices to the second device, wherein the first user interface signals include specification of the task;
wherein the second device is operable to:
receive the specification of the task to be performed from the first device;
determine one or more of the plurality of computing resources that are operable to perform the specified task;
invoke performance of the specified task by at least one of the plurality of computing resources, and/or the second device; and
provide second user interface signals to the first device, including results of the performance of the specified task; and
wherein the first device is further operable to:
receive the second user interface signals from the second device; and
provide the second user interface signals to one or more of the plurality of human interface devices for presentation to the user.

2. The system of claim 1, wherein the first device is further operable to:
send information describing at least a subset of the plurality of human interface devices to the second device.

3. The system of claim 2,
wherein the information describing at least a subset of the plurality of human interface devices comprises one or more of:
performance characteristics of the at least a subset of the plurality of human interface devices; and
I/O capabilities of the at least a subset of the plurality of human interface devices.

4. The system of claim 2, wherein the second device is further operable to:
provide interface instructions specifying operation of one or more of the plurality of human interface devices, in response to the information describing at least a subset of the plurality of human interface devices to the second device

5. The system of claim 4, wherein the first device is further operable to download the interface instructions specifying operation of one or more of the plurality of human interface devices and operate the one or more of the plurality of human interface devices accordingly.

6. The system of claim 2, wherein the second device is further operable to:
provide a graphical user interface (GUI) to the first device for display to the user on a display device in accordance with the information describing at least a subset of the plurality of human interface devices;
wherein the GUI is operable to receive user input specifying the task, and wherein the results of the performance of the specified task are displayed on the GUI.

7. The system of claim 2, wherein to provide the second user interface signals to the first device, the second device is further operable to:
compose the second user interface signals into a composite user interface signal in accordance with the information describing at least a subset of the plurality of human interface devices; and
provide the composite user interface signal to the first device.

8. The system of claim 7,
wherein to provide the composite user interface signal to the first device, the second device is further operable to:
compress the composite signal thereby generating a compressed composite signal; and
end the compressed composite signal to the first device;
wherein to receive the second user interface signals from the second device, and to provide the second user interface signals to one or more of the plurality of human interface devices for presentation to the user, the first device is further operable to:
receive the compressed composite signal from the second device;
decompress the compressed composite signal, thereby extracting the second user interface signals; and
provide the extracted second user interface signals to one or more of the plurality of human interface devices for presentation to the user.

9. The system of claim 1, wherein the network connection with the second device is established in response to one or more of:
user input to one of the human interface devices; and
power up of the first device.

10. The system of claim 1, wherein the plurality of computing resources includes at least one of:
one or more computing systems;
one or more storage devices;
one or more printers;
one or more scanners;
one or more cameras;
one or more plotters;
one or more control/automation devices;
one or more switches;
one or more transmission media;
one or more networks; and
one or more programs.

11. The system of claim 1, wherein the plurality of human interface devices includes at least a subset of:
one or more computer monitors;
one or more virtual reality (VR) displays;
a keyboard;
a pointing device;
a motion sensor;
one or more speakers;
one or more microphones;
one or more cameras;
one or more force-feedback devices; and
a card reader.

12. The system of claim 1, wherein the second device is coupled to the plurality of computing resources over the first network.

13. The system of claim 1, wherein the second device is coupled to the plurality of computing resources over one or more second networks.

14. The system of claim 1, wherein the second device is further operable to:
perform a discovery process to determine the plurality of computing resources coupled to the second device.

15. The system of claim 1, wherein the second device and one or more of the plurality of resources each comprise a computer, and wherein communication between computers is limited to human interface signals.

16. The system of claim 15, wherein the human interface signals comprise one or more of:
images;
sounds;
keyboard events; and
pointing device events.

17. The system of claim 1,
wherein the second device comprises:
a processor; and
a memory coupled to the processor, wherein the memory stores resource/session management software; and
wherein the second device is operable to execute the resource/session management software to perform said receiving, said determining, said invoking, and said providing.

18. A method for providing computer resources to users, comprising:
providing a first device, coupled to a plurality of human interface devices, and a second device, coupled to a plurality of computing resources;
the first device establishing a connection with the second device over a first network;
the first device providing first user interface signals generated by the plurality of human interface devices to the second device in response to first user input specifying a task to be performed, wherein the first user interface signals include the specification of the task;
the second device receiving the specification of the task to be performed from the first device;
the second device determining one or more of the plurality of computing resources that are operable to perform the specified task;
the second device invoking performance of the specified task by at least one of the plurality of computing resources, and/or the second device; and
the second device providing second user interface signals to the first device, including results of the performance of the specified task; and
the first device receiving the second user interface signals from the second device, and providing the second user interface signals to one or more of the plurality of human interface devices for presentation to the user.

19. The method of claim 18,
wherein the second device comprises:
a processor; and
a memory coupled to the processor, wherein the memory stores resource/session management software; and
wherein said receiving, said determining, said invoking, and said providing are performed by the second device executing the resource/session management software.

20. The method of claim 18, further comprising:
the first device send information describing at least a subset of the plurality of human interface devices to the second device.

21. The method of claim 20, further comprising:
the second device providing a graphical user interface (GUI) to the first device for display to the user on a display device in accordance with the information describing at least a subset of the plurality of human interface devices;
wherein the GUI is operable to receive user input specifying the task, and wherein the results of the performance of the specified task are displayed on the GUI.
